(19) United States
(12) Patent Application Publication
(10) Pub. No.: US 2020/0212486 A1
(43) Pub. Date: Jul. 2, 2020

(54) ELECTROLYTES FOR WIDE-TEMPERATURE RANGE LITHIUM ION BATTERIES

(71) Applicant: Battelle Memorial Institute, Richland, WA (US)

(72) Inventors: Wu Xu, Richland, WA (US); Bin Liu, Richland, WA (US)

(73) Assignee: Battelle Memorial Institute, Richland, WA (US)

(21) Appl. No.: 16/236,198

(22) Filed: Dec. 28, 2018

(51) Int. Cl. H01M 10/0567; H01M 10/0525; H01M 10/0569; H01M 10/0568

(52) U.S. Cl. CPC H01M 10/0567; H01M 10/0525; H01M 2300/0025; H01M 10/0568; H01M 10/0569

(57) ABSTRACT

Electrolytes for lithium ion batteries operable over a wide temperature range are disclosed. A lithium ion battery including a disclosed electrolyte may be operable over a temperature range of from −50 ° C. to 60 ° C. The electrolytes include a lithium salt, a non-aqueous carbonate-based solvent, a cesium salt and/or rubidium salt as a first additive, and two or more additional additives.

### ACKNOWLEDGMENT OF GOVERNMENT SUPPORT

This invention was made with Government support under Contract DE-AC05-76RL01830 awarded by the U.S. Department of Energy. The Government has certain rights in the invention.

### FIELD

This disclosure concerns electrolytes for lithium ion batteries operable over a wide temperature range.

### SUMMARY

Embodiments of electrolytes with additives to facilitate applications of lithium ion batteries (LIBs) over a wide temperature range are disclosed. Embodiments of battery systems including the disclosed electrolytes are also disclosed.

In some embodiments, an electrolyte comprises 0.2-2 M lithium salt; a nonaqueous carbonate-based solvent comprising one or more carbonate compounds; 0.01-0.2 M of a first additive, wherein the first additive comprises a cesium salt, a rubidium salt, or a combination thereof; 0.01-5 wt % of a second additive, wherein the second additive comprises a fluorinated cyclic carbonate compound or unsaturated cyclic carbonate compound, or a combination thereof; and 0.01-5 wt % of a third additive, wherein the third additive comprises organic phosphites, amines, imides, sultones, or a combination thereof. In any of the foregoing embodiments, the fluorinated cyclic carbonate compounds include, but are not limited to, fluoroethylene carbonate (FEC), difluoroethylene carbonate (DFEC), or a combination thereof, and the unsaturated cyclic carbonate compounds include, but are not limited to, vinylene carbonate (VC), vinyl ethylene carbonate (VEC), 4-methylene ethylene carbonate (MEC), 4,5-dimethylene ethylene carbonate (DMEC), or any combination thereof. In any of the foregoing embodiments, the phosphite compounds include, but are not limited to, tris(trimethylsilyl)phosphite (TTMSPi), the amine compounds include, but are not limited to, N-(trimethylsilyl)diethylamine (TMSDEA), the imide compounds include, but are not limited to, lithium bis(fluorosulfonyl)imide (LiFSI), and the sultone compounds include, but are not limited to, 1,3-propane sultone (PS). The second additive is not the same as the one or more carbonate compounds of the nonaqueous carbonate-based solvent. If the lithium salt comprises LiFSI, then the third additive does not comprise LiFSI. In some embodiments, the lithium salt comprises LiPF₆ and the first additive is CsPF₆.

In some embodiments, the electrolyte comprises 0.2-2 M lithium salt, 0.01-0.2 M of the first additive, 0.1-2 wt % of the second additive, and 0.1-2 wt % of the third additive. In certain embodiments, the electrolyte comprises 0.5-1.5 M lithium salt, 0.025-0.1 M of the first additive, 0.25-1 wt % of the second additive, and 0.25-2 wt % of the third additive.

In any of the above embodiments, the nonaqueous carbonate solvent may comprise ethylene carbonate (EC), propylene carbonate (PC), ethyl methyl carbonate (EMC), diethyl carbonate (DEC), dimethyl carbonate (DMC), or a combination thereof. In some embodiments, the nonaqueous carbonate-based solvent consists essentially of EC, PC, and EMC. The EC, PC, and EMC may be present in a weight ratio of 1:1:8. In an independent embodiment, the nonaqueous carbonate-based solvent consists essentially of EC, PC, EMC, DEC, and DMC. The EC, PC, EMC, DEC, and DMC may be present in a weight ratio of 1:1:4:2:2.

In some embodiments, the electrolyte comprises 1 M lithium salt provided by 0.7-1 M LiPF₆ and 0-0.3 M LiTFSI, LiBF_{4,} or a combination thereof; EC, PC, and EMC; 0.05 M CsPF₆; 0.25-0.5 wt % VC, 0.25-0.5 wt % FEC, or 0.25-0.5 wt % FEC+VC; and 0.5 wt % TTMSPi. In certain embodiments, the electrolyte further comprises 0.25-1 wt % PS, 0.25-1 wt % LiFSI, or a combination thereof.

In some embodiments, an LIB system comprises an anode, a cathode, and an electrolyte as disclosed herein, wherein the battery is operable over a temperature range of from −50° C. to 60° C. The anode may be a carbon based anode. The cathode may comprise a lithium transition metal oxide or a lithium transition metal phosphate.

In certain embodiments, the anode comprises graphite, the cathode comprises a lithium transition metal oxide, and the electrolyte comprises 0.5-1.5 M lithium salt, 0.025-0.1 M cesium salt as the first additive, 0.25-1 wt % of the second additive, and 0.25-2 wt % of the third additive.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic diagram of one exemplary embodiment of a rechargeable lithium ion battery.

FIGS. 2A-2F show discharge performance of graphite∥ NCA coin cells at 25° C. at a current density of 0.2 C with a control electrolyte comprising 1 M LiPF_{6,} EC/PC/EMC (1:1:8 by weight), and 0.05 M CsPF₆ (E1) and electrolytes based on E1 plus one or more additives as disclosed herein.

FIGS. 3A-3F show discharge performance of graphite∥NCA coin cells at −40° C. at a current density of 0.2 C with the control electrolyte E1 and electrolytes based on E1 plus one or more additives as disclosed herein.

FIGS. 4A-4C show discharge performance of graphite∥NMC333 pouch cells with electrolytes based on E1 plus a combination of additives as disclosed herein at a current density of 10 and temperatures of 25° C. (2A), −18° C. (2B), and −40° C. (20).

FIG. 5 shows the cold crank discharge performance of graphite∥NMC333 pouch cells with electrolytes based on E1 plus a combination of additives as disclosed herein at a cathode loading of 1.5 mAh·cm⁻², a current density of 4 C and a temperature of −40° C.

FIG. 6 shows the cycling performance of graphite∥NMC333 pouch cells with electrolytes based on E1 plus a combination of additives as disclosed herein at charge/discharge rates of 1 C/1 C under a voltage window between 3.0 V and 4.2 V for 1000 depth of discharge (DOD) cycles at 25° C.

FIG. 7 shows the change curves of direct resistance for the cells of FIG. 6.

FIG. 8 shows the gas generation characterizations of the pouch cells of FIG. 6 after 1000 cycles; the insets are optical images of the cycled pouch cells.

FIG. 9 shows the cold crank discharge performance of graphite∥NMC333 pouch cells with electrolytes based on E1 plus a combination of additives as disclosed herein at a cathode loading of 2.5 mAh·⁻², a current density of 4 C and a temperature of −40° C.

FIG. 10 shows the capacity retention of graphite∥NCA coin cells with electrolytes based on E1 plus a combination of additives as disclosed herein at charge/discharge rates of 1 C/1 C at for 300 cycles at 60° C.

FIGS. 11A-11F show transmission electron microscopy (TEM) images of NCA cathodes and graphite anodes recovered from coin cells after two initial formation cycles in the following electrolytes: E1 (11A, 11D), E2 (11B, 11E), and E3 (11C, 11F). E2 contains 98.5% E1, 0.5% FEC, 0.5% TTMSPi, 0.5% PS. E3 contains 99.0% E1, 0.5% FEC, 0.5% TTMSPi.

FIGS. 12A-12F shows X-ray photoelectron spectroscopy (XPS) narrow scans of F 1s spectra for NCA cathodes after two initial formation cycles with various electrolytes: E1 (12A), E2 (12B), E3 (12C), E1+0.5% FEC (12D), E1+0.5% TTMSPi (12E), and E1+0.5% PS (12F).

FIGS. 13A-13F show XPS narrow scans of F 1s spectra for graphite anodes after two initial formation cycles with various electrolytes: E1 (13A), E2 (13B), E3 (13C), E1+0.5% FEC (13D), E1+0.5% TTMSPi (13E), and E1+0.5% PS (13F).

FIGS. 14A-14D show XPS element quantification (Li, C, O, F, P, Si, S, Cs) for CEI on NCA cathode (14A, 14B) and SEI on graphite anode (14C, 14D) with different electrolytes (E1, E2, E3, E1+0.5% FEC, E1+0.5% TTMSPi, and E1+0.5% PS) after two initial formation cycles, and non-cycled cathode and anode as the comparison.

FIGS. 15A and 15B show the discharge performance of graphite∥NCA coin cells at 25° C. (15A) and −40° C. (15B) at a current density of 0.2 C with electrolytes based on E1 plus two or more additives as disclosed herein.

FIGS. 16A and 16B show the discharge performance of Gr∥NMC532 pouch cells at 25° C. (16A) and −40° C. (16B) at a current density of 10 with electrolytes based on E1 plus two or more additives as disclosed herein.

### DETAILED DESCRIPTION

Embodiments of electrolytes with additives to facilitate applications of LIBs over a wide temperature range are disclosed. In some embodiments, the electrolytes provide good cycling stability in LIBs at both low and elevated temperatures, such as a temperature range of from −50° C. to 60° C. Embodiments of battery systems including the disclosed electrolytes are also disclosed.

### I. Definitions and Abbreviations

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, molarities, voltages, capacities, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Definitions of common terms in chemistry may be found in Richard J. Lewis, Sr. (ed.), Hawley's Condensed Chemical Dictionary, published by John Wiley & Sons, Inc., 2016 (ISBN 978-1-118-13515-0).

In order to facilitate review of the various embodiments of the disclosure, the following explanations of specific terms are provided:

Additive: As used herein, the term “additive” refers to a component of an electrolyte that is present in an amount of greater than zero and less than or equal to 5 wt %.

Anode: An electrode through which electric charge flows into a polarized electrical device. From an electrochemical point of view, negatively-charged anions move toward the anode and/or positively-charged cations move away from it to balance the electrons leaving via external circuitry. In a discharging battery or galvanic cell, the anode is the negative terminal where electrons flow out. If the anode is composed of a metal, electrons that it gives up to the external circuit are accompanied by metal cations moving away from the electrode and into the electrolyte. When the battery is recharged, the anode becomes the positive terminal where electrons flow in and metal cations are reduced.

Carbon/silicon composite: As used herein, the term carbon/silicon composite refers to a material including both carbon (such as graphite and/or hard carbon) and silicon. A composite material is made from two or more constituent materials that, when combined, produce a material with characteristics different than those of the individual components. Carbon/silicon composites may be prepared, for example, by pyrolysis of pitch embedded with graphite and silicon powders (see, e.g., Wen et al., Electrochem Comm 2003, 5(2):165-168).

Carbonate-based solvent: A solvent in which the primary component (>50% of the solvent) is one or more organic carbonates.

Cathode: An electrode through which electric charge flows out of a polarized electrical device. From an electrochemical point of view, positively charged cations invariably move toward the cathode and/or negatively charged anions move away from it to balance the electrons arriving from external circuitry. In a discharging battery or galvanic cell, the cathode is the positive terminal, toward the direction of conventional current. This outward charge is carried internally by positive ions moving from the electrolyte to the positive cathode, where they may be reduced. When the battery is recharged, the cathode becomes the negative terminal where electrons flow out and metal atoms (or cations) are oxidized.

CEI: cathode electrolyte interphase

Cell: As used herein, a cell refers to an electrochemical device used for generating a voltage or current from a chemical reaction, or the reverse in which a chemical reaction is induced by a current. Examples include voltaic cells, electrolytic cells, and fuel cells, among others. A battery includes one or more cells. The terms “cell” and “battery” are used interchangeably when referring to a battery containing only one cell.

Coin cell: A small, typically circular-shaped battery. Coin cells are characterized by their diameter and thickness.

Coulombic efficiency (CE): The efficiency with which charges are transferred in a system facilitating an electrochemical reaction. CE may be defined as the amount of charge exiting the battery during the discharge cycle divided by the amount of charge entering the battery during the charging cycle. CE of Li∥Cu or Na∥Cu cells may be defined as the amount of charge flowing out of the battery during stripping process divided by the amount of charge entering the battery during plating process.

DEC: diethyl carbonate

DFEC: difluoroethylene carbonate

Depth of discharge (DOD): A measurement of the discharge state of a battery. DOD can be defined as capacity in Ah discharged from a fully charged battery divided by the battery nominal capacity, expressed as a percentage. For example, if a battery has a capacity of 100 Ah and 20 Ah is discharged, the DOD is 20%.

DMC: dimethyl carbonate

DMEC: 4,5-dimethylene ethylene carbonate

DPC: dipropyl carbonate

DTFEC: di(2,2,2-trifluoroethyl) carbonate

EC: ethylene carbonate

Electrolyte: A substance containing free ions that behaves as an electrically conductive medium. Electrolytes generally comprise ions in a solution, but molten electrolytes and solid electrolytes also are known.

EMC: ethyl methyl carbonate

FEC: fluoroethylene carbonate

Hard carbon: A non-graphitizable carbon material. At elevated temperatures (e.g., >1500° C.) a hard carbon remains substantially amorphous, whereas a “soft” carbon will undergo crystallization and become graphitic.

Intercalation: A term referring to the insertion of a material (e.g., an ion or molecule) into the microstructure of another material. For example, lithium ions can insert, or intercalate, into graphite (C) to form lithiated graphite (LiC₆ alloys).

LIB: lithium ion battery

LiBF₄: lithium tetrafluoroborate

LiFSI: lithium bis(fluorosulfonyl)imide

LiPF₆: lithium hexafluorophosphate

LiTFSI: lithium bis(trifluoromethanesulfonyl)imide

MEC: 4-methylene ethylene carbonate

MTFEC: methyl 2,2,2-trifluoroethyl carbonate

PC: propylene carbonate

PS: 1,3-propane sultone

SEI: solid electrolyte interphase

Separator: A battery separator is a porous sheet or film placed between the anode and cathode. It prevents physical contact between the anode and cathode while facilitating ionic transport.

Solution: A homogeneous mixture composed of two or more substances. A solute (minor component) is dissolved in a solvent (major component). A plurality of solutes and/or a plurality of solvents may be present in the solution.

TMSDEA: N-(trimethylsilyl) diethylamine

TTMSPi: tris(trimethylsilyl) phosphite

VC: vinylene carbonate

VEC: vinyl ethylene carbonate

### II. Electrolytes

Electrolytes for applications of LIBs over a wide temperature range are disclosed. In some embodiments, the electrolytes are useful for LIBs operating at low and/or elevated temperatures, such as temperatures ranging from −50° C. to 60° C., such as temperatures from - 40° C. to 60° C. The working temperature of an LIB is largely determined by the electrolyte composition, which not only affects the Li+ ion transport through the bulk electrolyte, but also determines the properties of the formed solid electrolyte interphase (SEI) layer on the anode surface and of the formed cathode electrolyte interphase (CEI) layer on the cathode surface.

Embodiments of the disclosed electrolytes include a lithium salt, a nonaqueous carbonate-based solvent comprising one or more carbonate compounds, a first additive comprising a cesium salt, a rubidium salt, or a combination thereof, and two or more other additives. Suitable lithium, cesium, and rubidium salt anions include, but are not limited to, PF₆⁻, BF₄⁻, AsF₆⁻, N(SO₂ CF₃)₂⁻, N(SO₂F)₂⁻, CF₃SO₃⁻, ClO₄⁻, ClO₃⁻, bis(oxalato)borate anion (BOB), difluoro(oxalate)borate anion (DFOB), I⁻, Br⁻, Cl⁻, F⁻, OH⁻, SCN⁻, NO₃, SO₄²⁻, PO₄³⁻ and combinations thereof. In some embodiments, the lithium and first additive salts have the same anion. In certain embodiments, a majority of the lithium salt has the same anion as the first additive salt.

In LIBs, CsPF₆ may facilitate formation of a uniform SEI layer on graphite electrodes in electrolytes comprising certain carbonate-based solvents (e.g., propylene carbonate). The inclusion of CsPF₆ as a first additive in the electrolyte reduces or prevents PC co-intercalation and graphite exfoliation even at a high PC content by forming an ultrathin SEI layer (e.g., <10 nm thick, such as 1-5 nm thick) on the graphite anode surface, which is permeable only to desolvated Li+ ions. The SEI layer effectively suppresses the PC co-intercalation and largely alleviates Li dendrite formation on the graphite anode. Thus, in some embodiments, the first additive is CsPF₆ and the lithium salt comprises LiPF₆.

In any of the above embodiments, the electrolyte may comprise 0.2-2 M lithium salt, such as 0.5-2 M or 0.5-1.5 M lithium salt. In some embodiments, the electrolyte comprises 1 M lithium salt, wherein the lithium salt is LiPF₆ or LiPF₆ in combination with LiTFSI, LiBF₄ or LiTFSI and LiBF₄. For example, the electrolyte may comprise 0.7-0.8 M LiPF₆ in combination with 0.2- 0.3 M LiTFSI and/or LiBF₄.

The solvent is a nonaqueous carbonate-based solvent comprising one or more carbonate compounds. In some embodiments, the solvent consists essentially of or consists of one or more carbonate compounds. “Consists essentially of” means that the solvent does not contain appreciable amounts (i.e., >5 wt %) other non-carbonate solvents, e.g., carboxylates, ethers, sulfones, nitriles, phosphates, hydrocarbons, etc. Exemplary carbonates include, but are not limited to, ethylene carbonate (EC), propylene carbonate (PC), ethyl methyl carbonate (EMC), diethyl carbonate (DEC), dimethyl carbonate (DMC), dipropyl carbonate (DPC), di(2,2,2-trifluoroethyl) carbonate (DTFEC), methyl 2,2,2-trifluoroethyl carbonate (MTFEC), and combinations thereof. EC is a common solvent for LIB electrolytes. EC facilitates formation of an SEI layer on an anode, e.g., a graphite anode. The SEI layer plays a key role in preventing further intercalation of solvent molecules into the graphite layered structure and/or prevents continuous decomposition of other electrolyte components. However, EC has a relatively high melting point (36.4° C.), which results in a high solidification temperature for the electrolyte and leads to a narrow temperature application range for most LIBs. Large amounts of EC (≥25 wt %) lead to very poor low-temperature performance of LIBs, such as poor performance at temperatures ≥0° C. EC can be replaced by PC (melting point −48.8° C.) to enhance low-temperature performance of LIBs. While PC widens the temperature range of LIBs, large amounts of PC result in irreversible capacity loss due to its inability to form a very stable SEI on the graphite anode surface, causing continuous solvent co-intercalation into the graphite and subsequent graphite exfoliation.

A combination of EMC, EC, and PC provides a wide temperature operating range while also providing a suitable SEI layer without the deleterious effects produced by high concentrations of EC and/or PC. In some embodiments, the inclusion of CsPF₆ additive in the electrolyte further suppresses PC co-intercalation and graphite exfoliation. In some embodiments, the nonaqueous carbonate-based solvent comprises EC, PC, EMC, or a combination thereof. In certain embodiments, the solvent comprises, consists essentially of, or consists of, EC, PC, and EMC. The relative amounts of EC, PC, and EMC are any amounts suitable to provide effective cycling of a LIB including the electrolyte. In some embodiments, the relative amounts of EC, PC, and EMC are 1:1:8, 1:2:7, or 2:1:7 by weight. In certain embodiments, the solvent comprises, consists essentially of, or consists of, EC, PC, and EMC in a ratio of 1:1:8 by weight.

In some embodiments, a combination of EMC, EC, PC and DEC, or EMC, EC, PC and DMC, or EC, PC, DEC, and DMC, or EMC, EC, PC, DEC, and DMC also provides a wide temperature operating range with a suitable SEI layer. In certain embodiments, the nonaqueous carbonate-based solvent comprises, consists essentially of, or consists of EC, PC, EMC, DEC, and DMC. The relative amounts of the carbonates are any mounts suitable to provide effective cycling of a lithium ion battery including the electrolyte. In one embodiments, the relative amounts of EC, PC, EMC, DEC, and DMC are 1:1:4:2:2 by weight.

In some embodiments, the electrolyte further comprises a cesium salt as the first additive. In any of the above embodiments, the electrolyte may comprise 0.01-0.2 M cesium salt as the first additive, such as 0.01-0.1 M or 0.025-0.1 M cesium salt. In certain examples, the electrolyte comprises 0.05 M CsPF_{6.}

The electrolyte further comprises a second additive. In some embodiments, the second additive comprises a fluorinated cyclic carbonate compound, an unsaturated cyclic carbonate compound, or a combination thereof. The second additive is not the same as the one or more carbonate compound(s) of the nonaqueous carbonate-based solvent. In certain embodiments, the fluorinated cyclic carbonate compounds include, but are not limited to, fluoroethylene carbonate (FEC), difluoroethylene carbonate (DFEC), or a combination thereof; and the unsaturated cyclic carbonate compounds include, but are not limited to, vinylene carbonate (VC), vinyl ethylene carbonate (VEC), 4-methylene ethylene carbonate (MEC), 4,5-dimethylene ethylene carbonate (DMEC), or a combination thereof.

The electrolyte further comprises a third additive. In some embodiments, the third additive comprises an organic phosphite compound, an amine, an imide, a sultone, or a combination thereof. In certain embodiments, the phosphite compounds include, but are not limited to, tris(trimethylsilyl)phosphite (TTMSPi), the amine compounds include, but are not limited to, N-(trimethylsilyl)diethylamine (TMSDEA), the sultone compounds include, but are not limited to, 1,3-propane sultone (PS), and the imide compounds include, but are not limited to, lithium bis(fluorosulfonyl)imide (LiFSI), or a combination thereof. If the lithium salt comprises LiFSI, then the third additive is not LiFS. In some embodiments, when the lithium salt comprises LiFSI, then the third additive comprises a phosphite, an amine, a sultone, or any combination thereof. In certain embodiments, if the lithium salt comprises LiFSI, then the third additive comprises TTMSPi, TMSDEA, PS, or a combination thereof. In some examples, the third additive comprises TTMSPi, PS, LiFSI, or a combination thereof. In one embodiment, the electrolyte comprises a second additive FEC and a third additive TTMSPi. In an independent embodiment, the electrolyte comprises a second additive FEC and a combination of third additives TTMSPi and PS. In another independent embodiment, the electrolyte comprises a second additive FEC and a combination of third additives TTMSPi, PS, and LiFSI. In another embodiment, the electrolyte comprises a second additive VC and a third additive TTMSPi. In an independent embodiment, the electrolyte comprises a second additive VC and a combination of third additives TTMSPi and LiFSI. In another independent embodiment, the electrolyte comprises a second additive VC and a combination of third additives TTMSPi, LiFSI, and PS.

In any of the above embodiments, the electrolyte may comprise 0.01-5 wt % of the second additive, such as 0.1-2 wt % or 0.25-1 wt % of the second additive. In any of the above embodiments, the electrolyte may comprise 0.01-5 wt % of the third additive, such as 0.1-2 wt % or 0.25-2 wt % of the third additive.

In some embodiments, the electrolyte comprises, consists essentially of, or consists of 0.2-2 M lithium salt, a nonaqueous carbonate-based solvent, 0.01-0.2 M of a first additive comprising a cesium salt, a rubidium salt, or a combination thereof, 0.01-5 wt % of a second additive comprising FEC, DFEC, VC, VEC, MEC, DMEC, or a combination thereof, and 0.01-5 wt % of a third additive comprising TTMSPi, TMSDEA, PS, LiFSI, or a combination thereof, wherein if the lithium salt comprises LiFSI, then the third additive comprises TTMSPi, TMSDEA, PS, or a combination thereof. In certain embodiments, the first additive is a cesium salt. “Consists essentially of” means that the electrolyte does not include any component that materially affects the properties of the electrolyte. For example, the electrolyte does not include any other electrochemically active component (i.e., a component (an element, an ion, or a compound) that is capable of forming redox pairs having different oxidation and reduction states, e.g., ionic species with differing oxidation states or a metal cation and its corresponding neutral metal atom) other than the lithium salt and the cesium and/or rubidium salt in an amount sufficient to affect performance of the electrolyte, does not contain >5 w % of a non-carbonate solvent, and does not include any additives besides those recited that materially affect the electrolyte properties. In an independent embodiment, the electrolyte comprises, consists essentially of, or consists of 0.2-2 M lithium salt, 0.01-0.2 M cesium salt as the first additive, 0.1-2 wt % of the second additive, and 0.1-2 wt % of the third additive. In another independent embodiment, the electrolyte comprises, consists essentially of, or consists of 0.5-1.5 M lithium salt, 0.025-0.1 M cesium salt as the first additive, 0.25-1 wt % of the second additive, and 0.25-2 wt % of the third additive.

In any of the above embodiments, the lithium salt may comprise LiPF_{6.} In one embodiment, the lithium salt is LiPF_{6.} In an independent embodiment, the lithium salt comprises LiPF₆ in combination with LiTFSI, LiBF₄, or LiTFSI and LiBF₄. In any of the above embodiments, the carbonate-based solvent may comprise EC, PC, EMC, or a combination thereof. In some embodiments, the carbonate-based solvent further comprises DEC and/or DMC. In certain embodiments, the carbonate-based solvent consists essentially of, or consists of, EC, PC, and EMC. In some examples, the EC, PC, and EMC are present in a weight ratio of 1:1:8. In certain embodiments, the carbonate-based solvent consists essentially of, or consists of EC, PC, EMC, DEC, and DMC. In some examples, the EC, PC, EMC, DEC, and DMC are present in a weight ratio of 1:1:4:2:2.

In any of the above embodiments, the first additive may be CsPF_{6.}

In any of the above embodiments, the second additive may comprise FEC, DFEC, VC, VEC, MEC or DMEC and the third additive may comprise TTMSPi. In one embodiment, the third additive comprises a combination of TTMSPi and PS. In an independent embodiment, the third additive comprises a combination of TTMSPi and LiFSI. In another independent embodiment, the third additive comprises a combination of TTMSPi, LiFSI, and PS. In some examples, the second additive comprises FEC or VC.

In some embodiments, the electrolyte comprises, consists essentially of, or consists of 1 M lithium salt provided by LiPF₆or LiPF₆ in combination with LiTFSI and/or LiBF₄, EC/PC/EMC or EC/PC/EMC/DEC/DMC, 0.05 M CsPF_{6,} FEC and/or VC, TTMSPi, 0-5 wt % PS, and 0-5 wt % LiFSI. In certain embodiments, the electrolyte comprises, consists essentially of, or consists of 1 M lithium salt provided by LiPF₆ or LiPF₆ in combination with LiTFSI and/or LiBF₄, EC/PC/EMC (1:1:8 by weight) or EC/PC/EMC/DEC/DMC (1:1:4:2:2 by weight), 0.05 M CsPF₆, 0.25-0.5 wt % FEC or 0.25-0.5 wt % VC, 0.5 wt % TTMSPi, 0-0.5 wt % PS, and 0-1 wt % LiFSI. In one embodiment, the electrolyte consists essentially of 0.8 M LiPF6, 0.2 M LiTFSI, EC/PC/EMC (1:1:8 by weight), 0.05 M CsPF₆, 0.25 wt % VC, 0.5 wt % TTMSPi, 0.5 wt % PS, and 0.25 wt % LiFSI. In an independent embodiment, the electrolyte consists essentially of 1 M LiPF_{6,} EC/PC/EMC (1:1:8 by weight), 0.05 M CsPF₆, 0.5 wt % FEC, and 0.5 wt % TTMSPi. In another independent embodiment, the electrolyte consists essentially of 1 M LiPF_{6,} EC/PC/EMC (1:1:8 by weight), 0.05 M CsPF₆, 0.5 wt % VC, 0.5 wt % TTMSPi, and 0.5 wt % LiFSI. In another independent embodiment, the electrolyte consists essentially of 0.7 M LiPF₆, 0.3 M LiBF₄, EC/PC/EMC (1:1:8 by weight), 0.05 M CsPF6, 0.25 wt % VC, 0.5 wt % TTMSPi, 0.5 wt % PS, and 0.25 wt % LiFSI. In another independent embodiment, the electrolyte consists essentially of 1 M LiPF_{6,} EC/PC/EMC (1:1:8 by weight), 0.05 M CsPF6, 0.25 wt % FEC, 0.5 wt % TTMSPi, 0.5 wt % PS, and 0.25 wt % LiFSI. In another independent embodiment, the electrolyte consists essentially of 1 M LiPF_{6,} EC/PC/EMC/DEC/DMC (1:1:4:2:2 by weight), 0.05 M CsPF₆, 0.25 wt % FEC, 0.5 wt % TTMSPi, 0.5 wt % PS, and 0.25 wt % LiFSI.

### III. Batteries

Embodiments of the disclosed electrolytes are useful in rechargeable batteries, such as LIBs. In some embodiments, the electrolytes are useful for LIBs operating at temperatures ranging from −50 to 60° C., such as from −40 to 60° C.

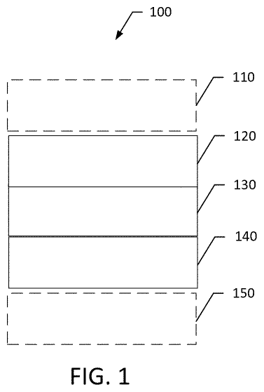

In some embodiments, an LIB comprises an electrolyte as disclosed herein, a cathode, an anode, and optionally a separator. FIG. 1 is a schematic diagram of one exemplary embodiment of a rechargeable LIB 100 including a cathode 120, a separator 130 which is infused with an electrolyte, and an anode 140. In some embodiments, the battery 100 also includes a cathode current collector 110 and/or an anode current collector 150.

In some embodiments, the anode is a carbon-based (e.g., graphite- and/or hard carbon-based), silicon-based, carbon- and silicon-based (e.g., a carbon/silicon composite), tin-based, or antimony-based anode. By “carbon-based anode” is meant that a majority of the total anode mass is activated carbon material, such as at least 70 wt %, at least 80 wt %, or at least 90 wt % activated carbon material, e.g., graphite, hard carbon, or a mixture thereof. By “silicon-based anode” is meant that a majority of the total anode mass is silicon, such as at least 70 wt %, at least 80 wt %, or at least 90 wt % silicon. By “carbon/silicon-based anode” is meant that a majority of the total anode mass is activated carbon and silicon, such as at least 70 wt %, at least 80 wt %, or at least 90 wt % activated carbon and silicon. By “tin-based anode” or “antimony-based anode” is meant that a majority of the total anode mass is tin or antimony, respectively, such as at least 70 wt %, at least 80 wt %, or at least 90 wt % tin or antimony, respectively. The anode may further include one or more binders and/or conductive additives, e.g., as described above. In some embodiments, the anode is a graphite- and/or silicon-based anode. In certain embodiments, the anode is a graphite-based anode.

In some embodiments, the cathode is a lithium transition metal oxide cathode (e.g., LiCoO_{2,} LiNiₓMn_{y}Co_{z}O₂ (NMC where x+y+z=1), LiNi_{0.80}Co_{0.15}Al_{0.05}O₂ (NCA), LiMn₂O_{4,} etc) or a lithium transition metal phosphate cathode (e.g., LiFePO₄). In certain embodiments, the cathode is NCA or LiNi_{1/3}Mn_{1/3}Co_{1/3}O₂ (NMC333).

The separator may be glass fiber, a porous polymer film (e.g., polyethylene- or polypropylene-based material) with or without a ceramic coating, or a composite (e.g., a porous film of inorganic particles and a binder). One exemplary polymeric separator is a Celgard® K1640 polyethylene (PE) membrane. Another exemplary polymeric separator is a Celgard® 2500 polypropylene membrane. Another exemplary polymeric separator is a Celgard® 3501 surfactant-coated polypropylene membrane. The separator may be infused with the electrolyte.

The current collectors can be a metal or another conductive material such as, but not limited to, nickel (Ni), copper (Cu), aluminum (Al), iron (Fe), stainless steel, or conductive carbon materials. The current collector may be a foil, a foam, or a polymer substrate coated with a conductive material. Advantageously, the current collector is stable (i.e., does not corrode or react) when in contact with the anode or cathode and the electrolyte in an operating voltage window of the battery. The anode and cathode current collectors may be omitted if the anode or cathode, respectively, are free standing, e.g., when the anode is metal or a free-standing film comprising an intercalation material or conversion compound, and/or when the cathode is a free-standing film. By “free-standing” is meant that the film itself has sufficient structural integrity that the film can be positioned in the battery without a support material.

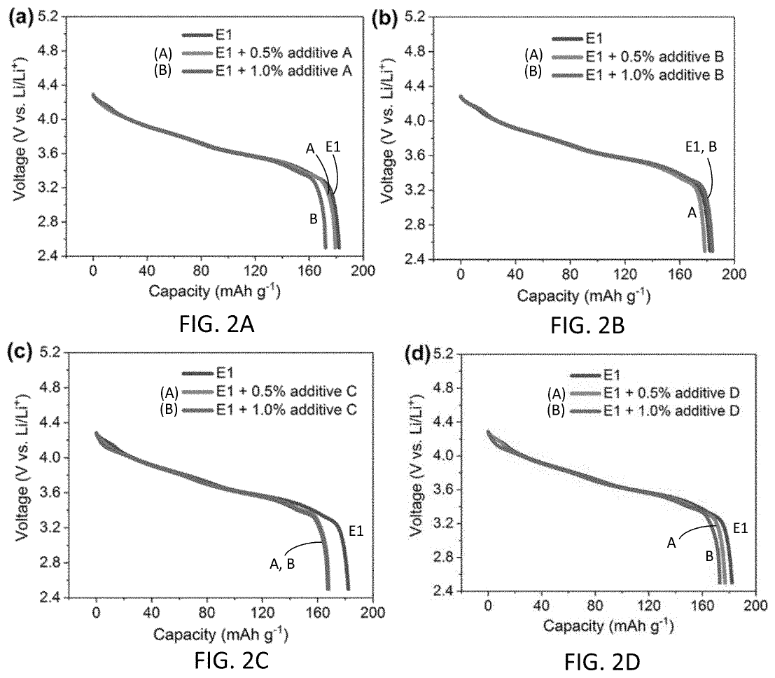

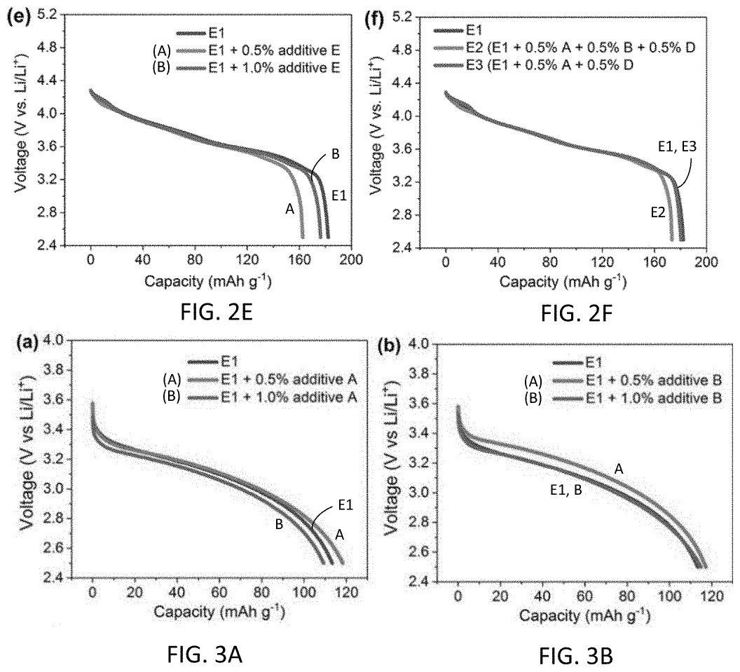

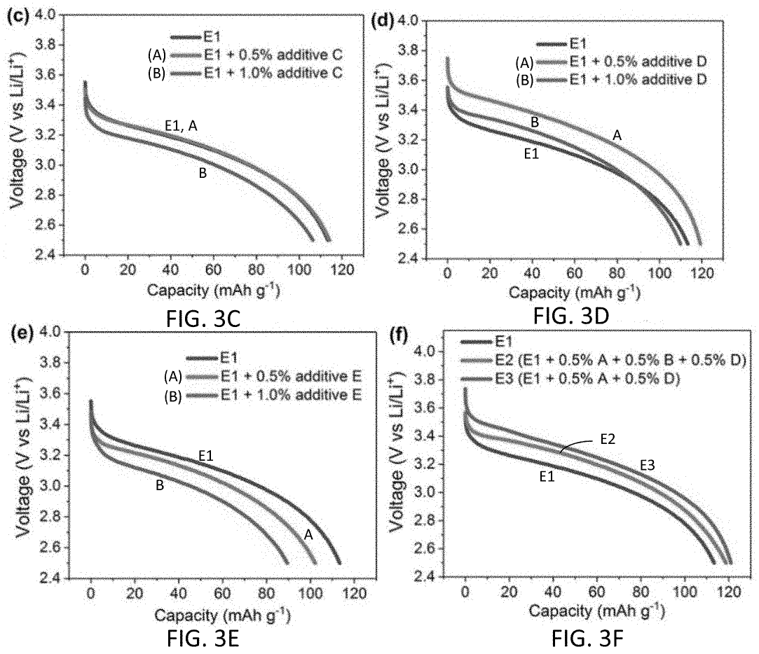

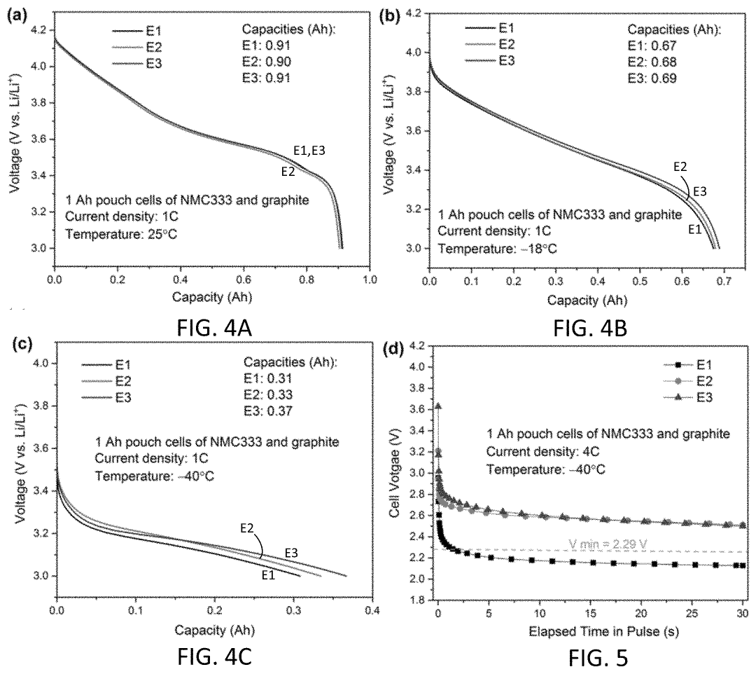

In some embodiments, as compared to electrolytes without the first and second additives, the disclosed electrolytes provide LIBs with improved discharging performance at −40° C., improved capacity retention, and/or enhanced cycling stability at high temperatures (e.g., 60° C.). For instance, as shown in the examples below, LIBs comprising an electrolyte including FEC and TTMSPi (electrolyte E2) or an electrolyte including FEC, TTMSPi and PS (electrolyte E3) provide improved discharging performance over temperatures ranging from −40° C. to 60° C. compared to an LIB including a comparable electrolyte without the additives (FIGS. 1F, 2A-2C). LIBs with the same electrolytes also exhibited greatly improved cold crank performance at −40° C. at a 4 C rate with the voltage remaining above the required minimum voltage (Vₘᵢₙ) line (FIG. 3). The electrolytes also provide the LIBs with increased capacity retention over at least 1000 cycles at 25° C. (FIG. 4) and over at least 300 cycles at 60° C. (FIG. 7). Without wishing to be bound by a particular theory of operation, these improvements are attributed at least in part to formation of ultra-thin SEI films on the cathode and the anode surfaces after formation cycles of the LIBs.

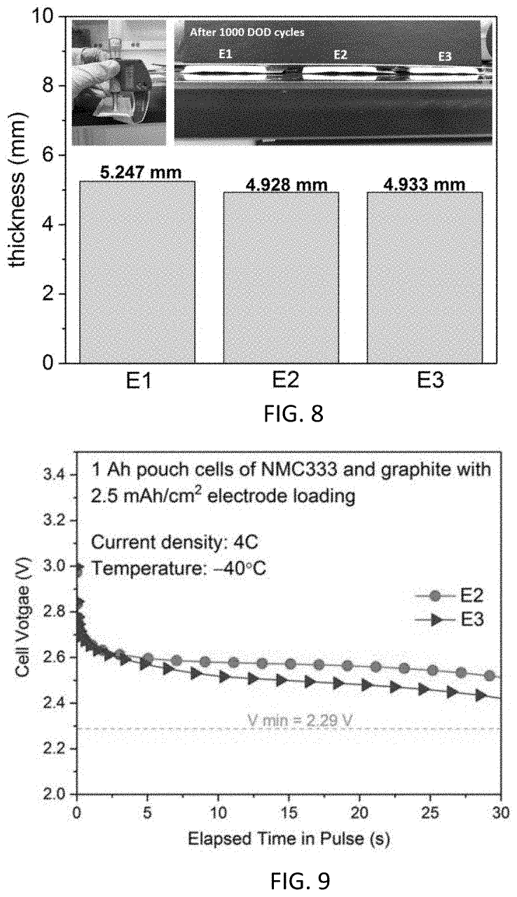

In certain embodiments, the presence of PS as an additive suppresses gas generation during operation of the battery, which may be especially advantageous in pouch cells. Addition of small amounts of LiFSI may further modify the SEI layer and increase conductivity at ambient temperature; however, large amounts of LiFSI may result in capacity fading at low temperatures. For instance, an LIB with an electrolyte including VC, TTMSPi and 0.5 wt % LiFSI (electrolyte E5) exhibited improved discharging performance at −40° C. relative to a comparable electrolyte without LiFSI (electrolyte E4) or a comparable electrolyte with 1.0 wt % LiFSI (electrolyte E6) (FIG. 8).

In some embodiments, the combination of second and third additives provides a synergistic benefit compared to the additive benefits of the second and third additives separately. For instance, X-ray photoelectron spectroscopy results demonstrate a synergistic effect of FEC, TTMSPi and PS on the CEI and SEI layers on NCA cathodes and graphite anodes.

### IV. EXAMPLES

Materials: LiNi_{0.80}Co_{0.15}Al_{0.05}O₂ (NCA) cathodes (1.5 mAh·⁻²) and graphite anodes (1.53 mAh·⁻²) obtained from Argonne National Laboratory (ANL) were used in coin cells. LiNi_{1/3}Mn_{1/3}Co_{1/3}O₂ (NMC333) cathode sheets (1.5 mAh cm⁻²) and graphite anode sheets (1.65 mAh·⁻²) were used in pouch cells made in the Advanced Battery Facility (ABF) at Pacific Northwest National Laboratory (PNNL). Celgard® 2500 (polypropylene) was used as the separator in coin cells and pouch cells. LiPF_{6,} EC, PC, EMC, VC, and FEC of battery grade were ordered from BASF Battery Materials and were used as received. CsPF₆ (≥99.0%) was purchased from SynQuest Laboratories (Alachua, Fla.). In addition, some additives, such as PS (≥98%), TTMSPi (≥95%), and N-(trimethylsilyl)diethylamine (TMSDEA, ≥98%) were ordered from Sigma-Aldrich. Various electrolytes were prepared inside an argon-filled glovebox (MBraun), where both O₂ and H₂O levels were below 1 ppm.

Electrochemical Measurements and Characterizations: The electrochemical performances of graphite∥NCA 2032-type coin cells filled with 100 μL of various electrolytes were evaluated on Land battery testers, where 1 C rate corresponded to a current density of 1.5 mA·cm⁻². 1 Ah graphite∥NMC pouch cells with stacked electrodes were made at the ABF, PNNL and evaluated on an Arbin® BT2000 battery tester, in which 1 C corresponded to a current of 1.0 A. All cells were tested under galvanostatic charge-discharge cycles at different temperatures inside TestEquity® temperature chambers (TestEquity LLC, Moorpark, Calif.) or Tenney JR environmental chambers (Thermal Product Solutions, New Columbia, Pa.). Above coin cells and pouch cells experienced two initial formation cycles at a current density of C/20 at room temperature, followed by selected testing protocols. The cutoff voltages of these full cells were set at 2.5 V for discharge process and 4.3 V for charge process. In case of low-temperature discharge tests, the coin cells and pouch cells were galvanostatically charged to 4.3 V at C/5 and then held potentiostatically at 4.3 V to C/10 at room temperature, kept in the temperature chamber at the specified testing temperature for 6 h to reach thermal equilibrium, and then discharged at C/5 at the selected temperature. For room temperature cycling tests of graphite∥NMC pouch cells, the cells were cycled at 1 C/1 C for charge/discharge with a voltage window of 3.0 V and 4.2 V at 25° C. For high temperature cycling evaluation of graphite∥NCA coin cells, the cells were cycled at 1 C/1 C for charge/discharge with a voltage window of 2.5V and 4.3 V at 60° C. The graphite and NCA electrodes after two formation cycles were recovered from the graphite∥NCA full cells, soaked in anhydrous EMC solvent for 30 min, rinsed with fresh EMC three times, and dried under vacuum inside the antechamber of the glovebox.

A baseline electrolyte E1 (1 M LiPF₆ in EC/PC/EMC (1:1:8 by weight) with 0.05 M CsPF₆) was prepared. Individual additives and additive combinations were included in E1 and evaluated for low-temperature battery performance in coin cells with NCA cathodes and graphite anodes. FEC (additive A), PS (additive B), TMSDEA (additive C), TTMSPi (additive D), and VC (additive E) were added to E1 at concentrations of 0.5 and 1.0 wt %. Additionally, two electrolytes, E2 and E3 with combinations of additives were prepared:

E2 -E1+0.5 wt % FEC+0.5 wt % TTMSPi+0.5 wt % PS

E3 -E1+0.5 wt % FEC+0.5 wt % TTMSPi

After two formation cycles, the coin cells were discharged at 25° C. and at −40° C. at a current density of 0.2 C (1 C=1.5 mA·cm⁻²) at a current density of 1 C. FIGS. 2A-2F and 3A-3F show the results at 25° C. and −40° C., respectively. Most of the electrolytes exhibited similar behavior to the baseline E1 at 25° C. Electrolytes including TMSDEA (additive C, FIG. 2C) and VC (additive E, FIG. 2E) had a detrimental effect on discharge performance at room temperature. At −40° C., electrolytes including 0.5 wt % FEC (additive A, FIG. 3A), 0.5 wt % PS (additive B, FIG. 3B), and 0.5 wt % TTMSPi (additive D, FIG. 3D) provided superior discharging performance at −40° C. compared to the electrolytes including TMSDEA (additive C, FIG. 3C) and VC (additive E, FIG. 3E). The coin cells with electrolytes E2 and E3 demonstrated further enhanced low-temperature performance, particularly with E3 (FIG. 3F).

Electrolytes E1, E2, and E3 were further evaluated in 1 Ah pouch cells with a LiNi_{1/3}Mn_{1/3}Co_{1/3}O₂ (NMC333) cathode (electrode loading of 1.5 mAh·cm⁻²) and graphite anode at a current density of 1 C (1.5 mAh·⁻²) to a cutoff voltage of 3 V at temperatures of 25° C. (FIG. 4A), −18° C. (FIG. 4B), and −40° C. (FIG. 4C). The results show that the discharge curves of all three electrolytes were very similar at 25° C., while E2 and E3 had better discharging performance than E1 at −18° C. The pouch cells with electrolytes E2 and E3 also provided enhanced low-temperature performance at −40° C. compared to the baseline electrolyte E1.

FIG. 5 shows the cold crank response performance of the pouch cells at a current density of 4 C at −40° C. The discharge curves of the pouch cells with E2 and E3 were very stable and were much higher than the Vₘᵢₙ line (2.29 V), which is required by most cold crank applications, thus demonstrating a very good cold crank response. In contrast, the voltage values of the pouch cell including E1 dropped quickly below the Vₘᵢₙ line.

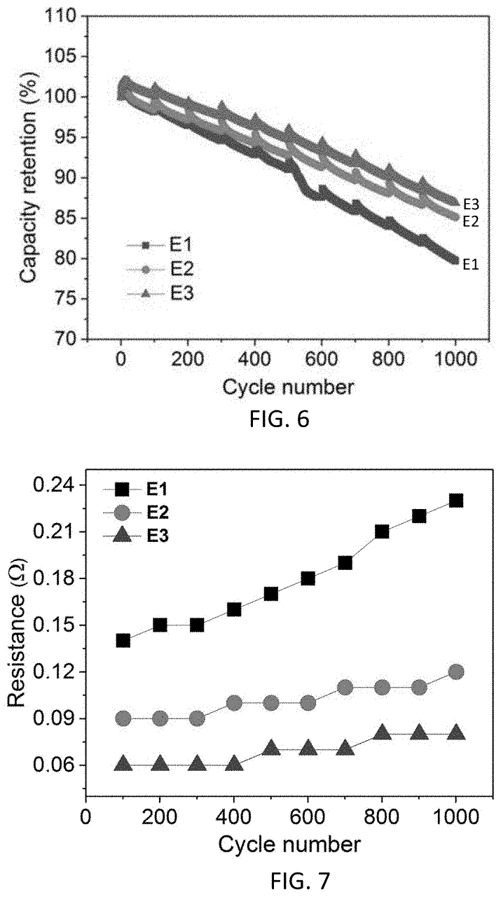

The long-term cycling performance of the pouch cells was evaluated at discharge/charge rates of 1 C/1 C (1 C=1.5 mA·cm⁻²) under a voltage window between 3.0 V and 4.2 V for 1000 depth of discharge (DOD) cycles at 25° C. Although the pouch cells with E1 had good cycling durability with capacity retention of 80%, the capacity retentions of the pouch cells with E2 and E3 were surprisingly higher at 85% and 87%, respectively after 1000 cycles (FIG. 6).

The corresponding direct current resistance (DCR) values of the pouch cells were periodically tested during the 1000 cycles, and the results are shown in Table 1 and FIG. 7. The pouch cells with the control electrolyte E1 showed relatively higher DCR values (from 0.14 Ω to 0.23 Ω for 900 cycles) when compared to those values from the cells with E2 and E3, where the DCR values increased from 0.09 Ω to 0.12 Ω for E2 and from 0.06 Ω to 0.08 Ω for E3 in 900 cycles. The DCR results were fully consistent with above cycling curves reflected in FIG. 6, demonstrating the remarkably enhanced cycling stability of pouch cells containing E2 and E3.

TABLE 1
DCR results of 1 Ah graphite∥NMC333
pouch cells at selected cycle numbers

| E1 | | E2 | | E3 | |
|---|---|---|---|---|---|
| Cycle # | DCR (Ω) | Cycle # | DCR (Ω) | Cycle # | DCR (Ω) |
| 101 | 0.14 | 101 | 0.09 | 101 | 0.06 |
| 201 | 0.15 | 201 | 0.09 | 201 | 0.06 |
| 301 | 0.15 | 301 | 0.09 | 301 | 0.06 |
| 401 | 0.16 | 401 | 0.10 | 401 | 0.06 |
| 501 | 0.17 | 501 | 0.10 | 501 | 0.07 |
| 601 | 0.18 | 601 | 0.10 | 601 | 0.07 |
| 701 | 0.19 | 701 | 0.11 | 701 | 0.07 |
| 801 | 0.21 | 801 | 0.11 | 801 | 0.08 |
| 901 | 0.22 | 901 | 0.11 | 901 | 0.08 |
| 1001 | 0.23 | 1001 | 0.12 | 1001 | 0.08 |

After cycling, the thickness change of the pouch cells was evaluated (FIG. 8). The insets are optical images of the cycled pouch cells. The thicknesses were 5.247 mm, 4.928 mm, and 4.933 mm for cells with E1, E2, and E3, respectively, demonstrating that the electrolytes with additives provided cycling stability over long-term cycling. The addition of PS to form E2 further decreased gas generation, indicating that PS is an efficient additive for gas generation suppression.

The effect of high electrode loading on the cold crank response of 1 Ah pouch cells was evaluated with a cathode loading of 2.5 mAh·⁻² in electrolyte E2 and E3. Although the cathode loading was increased from 1.5 mAh·⁻² to 2.5 mAh·⁻², the excellent cold crank response performance at a current density of 4 C (1 C=2.5 mA·cm⁻²) at −40° C. was retained as shown in FIG. 9.

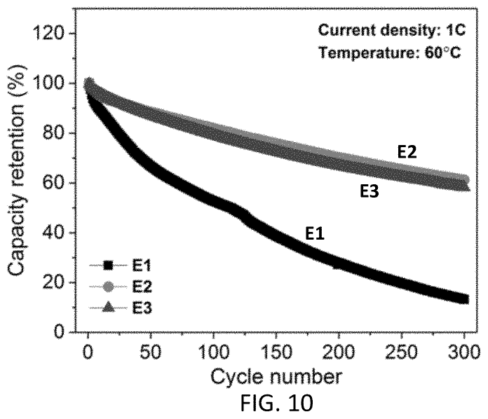

The high-temperature cycling performance of E1, E2, and E3 was further evaluated at 60° C. in graphite∥NCA coin cells. The coin cells were charged and discharged at 1 C/1 C rates at 60° C. for 300 cycles. As shown in FIG. 10, the coin cells with E2 and E3 vastly outperformed the coin cell with E1. Addition of a certain amount of PS (E2) suppresses the gas generation so the high-temperature cycling performance is slightly better than the electrolyte without PS (E3). Previous work had shown that the EC content of the solvent was a dominant element for high performance at elevated temperature (60° C.) and that cycling stability gradually increased as EC content increased from 10% to 50%. The results in FIG. 10 demonstrate that a combination of additives as disclosed herein also play an important role in contributing to cell performance enhancement at elevated temperatures.

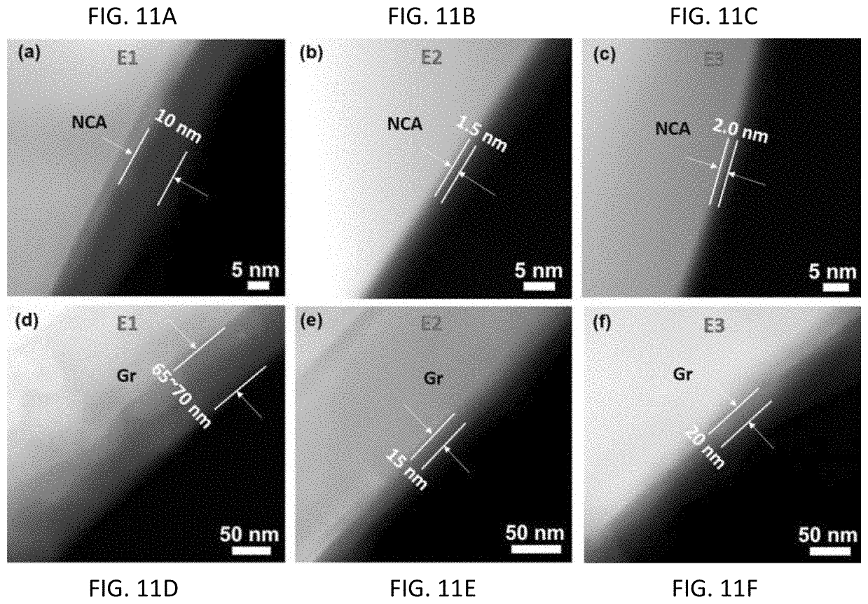

Optimized E2 and E3 electrolytes signifcantly promote formation of much thinner SEI formation on both NCA cathode and graphite anode, compared to the baseline E1, as shown by the transmission electron microscopy (TEM) images in FIGS. 11A-11F. More importantly, E2 with three additives (FEC, TTMSPi and PS) provides an obvious decrease in thicknesses of the CEI on NCA cathode and SEI on graphite anode surfaces, thus indicating unqiue ultrathin SEI and CEI formation due to the synergistic benefit of multiple electrolyte additives in the electrolyte.

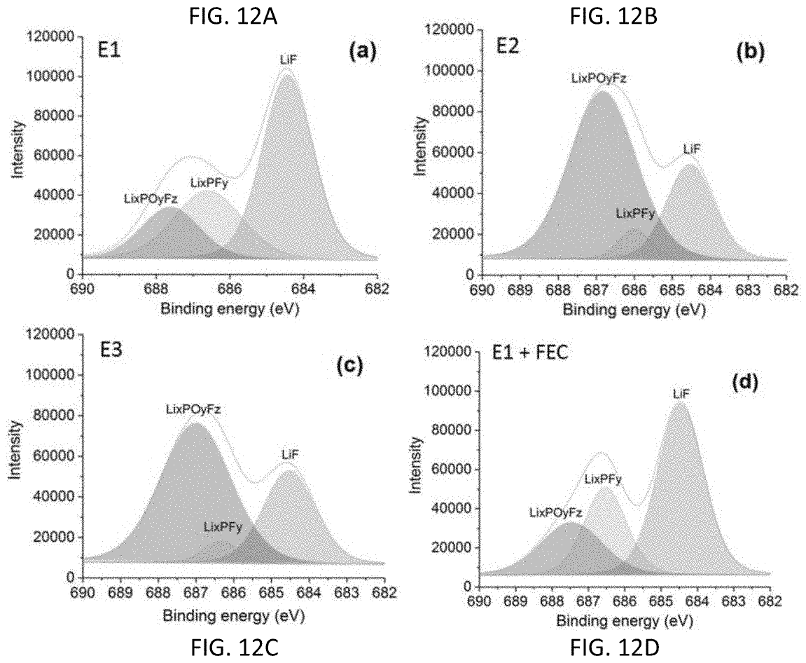

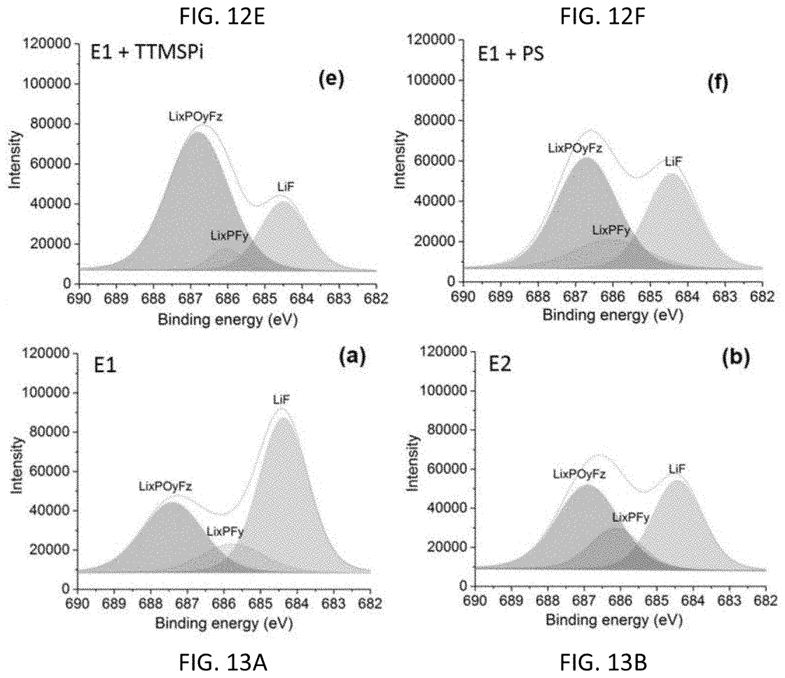

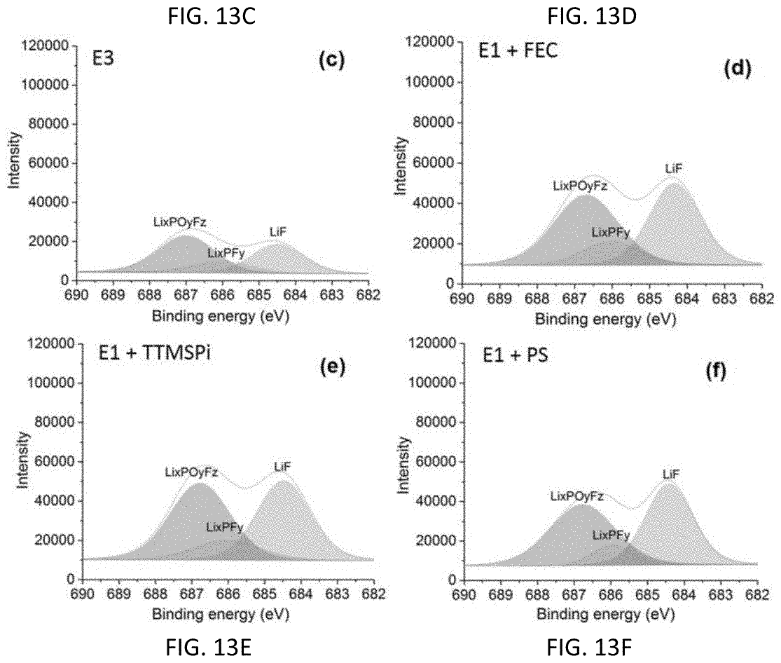

Besides the above thickness change of SEI with different electrolytes, the components of CEI and SEI films with different electrolytes (E1, E2, E3, E1+0.5% FEC, E1+0.5% TTMSPi, and E1+0.5% PS), characterized by X-ray photoelectron spectroscopy (XPS), are quite different on NCA cathode and graphite anode, as illustrated in FIGS. 12A-12F and 13A-13F, respectively. Above results reveal that different additive combinations affect the compositions of both CEI and SEI, which in turn directly affect battery performance in a wide-temperature range.

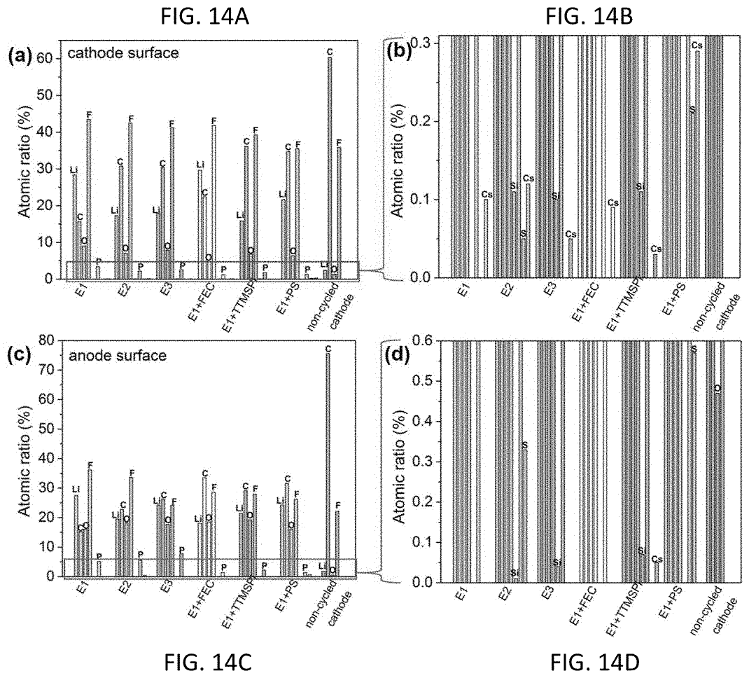

Furthermore, the XPS element quantifications for CEI on NCA cathode (FIGS. 14A 14B) and SEI on graphite anode (FIGS. 14C, 14D) after two initial formation cycles are provided. Different additives in electrolytes basically govern the contents of elements in the surface layers on cathodes and anodes. In this analysis, Si detected by XPS is attributed to decomposition of TTMSPi additive, S is from decomposition of PS additive, whereas partial F is due to decomposition of FEC. In particular, some Cs can be found on the anode surface in E1 containing 0.5% TTMSPi, while there is no Cs signal on anodes with other electrolytes, as shown in FIG. 14D. Overall, in view of electrochemical testing results and post-characterization analysis, it is worth noting that such a synergistic effect induced by multiple additive combination makes a huge contribution to wide-temperature electrolyte development for next-generation LIB applications.

Additional electrolytes E4-E15 were prepared as shown in Table 2.

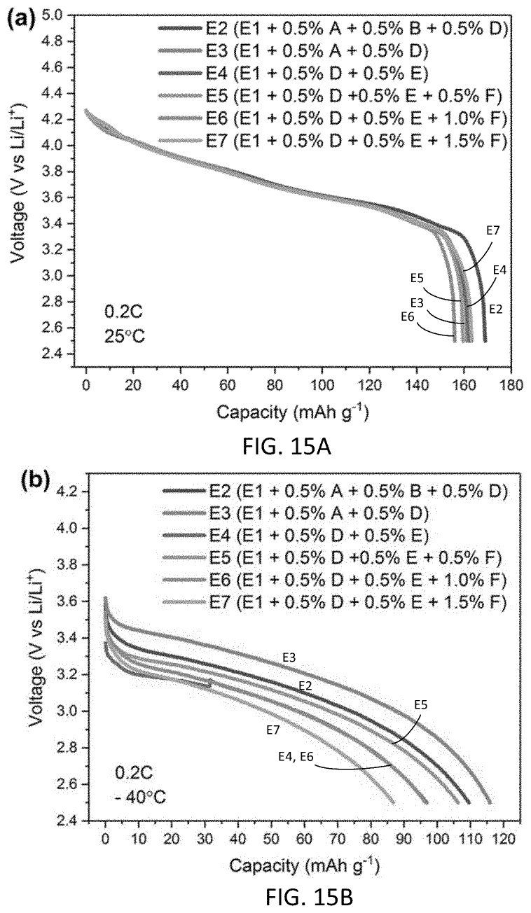

Graphite∥NCA coin cells were prepared with electrolytes E2-E7 and evaluated at a discharge rate of 0.2 C at 25° C. and −40° C. The results are shown in FIGS. 15A (25° C.) and 12B (−40° C.), where additive F is LiFSI and additives A-E are as previously described. The results demonstrate that E5 provides low-temperature performance comparable to that of E2, making E5 an alternative candidate for low-temperature performance improvement of Li ion cells. The results also show that large amounts of LiFSI (more than 0.5 wt %, electrolytes E6 and E7) cause capacity fading at −40° C. Of note, the graphite anodes used in FIGS. 15A-15B were slightly different from the graphite anodes used in earlier coin cells; the discharge performances were slightly decreased with the new graphite anodes, but the performance comparisons remained consistent.

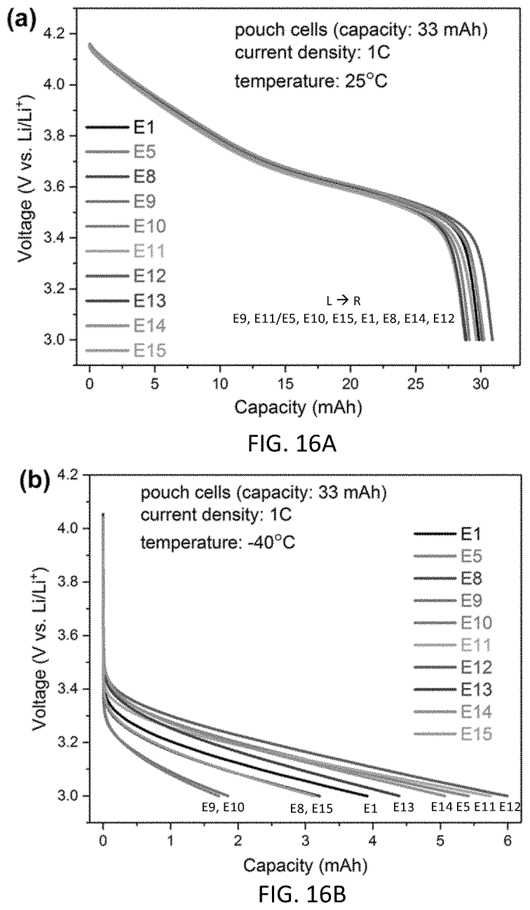

Small pouch cells (33 mAh) of Graphite∥NMC532 with a cathode loading of 1.2 mAh·cm⁻² were evaluated with electrolytes E1, E5, and E8-E15 (see Table 2). Two formation cycles at C/20 charging and C/10 discharging at 25° C. were performed, followed by evaluating discharge performance at 1 C at 25° C. and −40° C. (FIGS. 16A and 16B, respectively). Although the differences in discharging capacity were not so clear at 25° C. (FIG. 16A), the differences in low-temperature behavior at −40° C. can be obviously seen in FIG. 16B). In particular, significantly enhanced low-temperature performance of pouch cells based on E5, E1, E12, E13, and E14 was superior over that of pouch cells with the E1 baseline electrolyte.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

TABLE 2
Electrolyte Formulations with weight percentages for each component

| | Electrolyte code | | | | | | | | | | | | | | |
|---|---|---|---|---|---|---|---|---|---|---|---|---|---|---|---|
| | E1 | E2 | E3 | E4 | E5 | E6 | E7 | E8 | E9 | E10 | E11 | E12 | E13 | E14 | E15 |
| LiPF₆ | 13.01 | 12.81 | 12.88 | 12.88 | 12.88 | 12.75 | 12.88 | 10.4 | 15.16 | 12.82 | 9.05 | 10.17 | 12.82 | 12.78 | 12.74 |
| CsPF₆ | 1.19 | 1.17 | 1.18 | 1.18 | 1.18 | 1.17 | 1.16 | 1.2 | 1.17 | 1.17 | 1.19 | 1.17 | 1.17 | 1.18 | 1.17 |
| EC | 8.58 | 8.45 | 8.49 | 8.49 | 8.49 | 8.41 | 8.37 | 8.69 | 8.21 | 8.45 | 8.59 | 8.23 | 8.45 | 8.46 | 8.41 |
| PC | 8.58 | 8.45 | 8.49 | 8.48 | 8.49 | 8.41 | 8.37 | 8.69 | 8.21 | 8.45 | 6.59 | 8.23 | 8.45 | 8.46 | 8.41 |
| EMC | 68.64 | 67.61 | 67.95 | 67.95 | 67.95 | 67.27 | 66.92 | 69.52 | 65.75 | 67.61 | 68.69 | 65.9 | 67.61 | 33.82 | 67.27 |
| TTMSPi | | 0.5 | 0.5 | 0.5 | 0.5 | 0.5 | 0.5 | 0.5 | 0.5 | 0.5 | 0.5 | 0.5 | 0.5 | 0.5 | 0.5 |
| FEC | | 0.5 | 0.5 | | | | | | | | | | 0.25 | 0.25 | |
| PS | | 0.5 | | | | | | | | 0.5 | 0.5 | 0.5 | 0.5 | 0.5 | 0.5 |
| VC | | | | 0.5 | 0.5 | 0.5 | 0.5 | 0.5 | 0.5 | 0.25 | 0.25 | 0.25 | | | 0.5 |
| LiFSI | | | | | 0.5 | 1 | 1.5 | 0.5 | 0.5 | 0.25 | 0.25 | 0.25 | 0.25 | 0.25 | 0.5 |
| LiBF₄ | | | | | | | | | | | 2.39 | | | | |
| LiTFSI | | | | | | | | | | | | 4.8 | | | |
| DEC | | | | | | | | | | | | | | 16.9 | |
| DMC | | | | | | | | | | | | | | 16.9 | |

Note:
LiPF₆: Lithium hexafluorophosphate
EC: Ethylene carbonate
EMC: Ethyl methyl carbonate
FEC: Fluoroethylene carbonate
VC: Vinylene carbonate
LiBF₄: Lithium tetrafluoroborates
DEC: Diethyl carbonate
CsPF₆: Cesium hexafluorophosphate
PC: Propylene carbonate
TTMSPi: Tris(trimethylsily)phosphite
PS: 1,3-Propanesultone
LiFSI: Lithium bis(flurosulfonyl)imide
LiTFSI: Lithium bis(trifluoromethanesulfonyl)imide
DMC: Dimethyl carbonate

We claim:

1. An electrolyte, comprising:
2-2 M lithium salt;
a nonaqueous carbonate-based solvent comprising one or more carbonate compounds;
01-0.2 M of a first additive, wherein the first additive comprises a cesium salt, a rubidium salt, or a combination thereof;
01-5 wt % of a second additive, wherein the second additive comprises a fluorinated cyclic carbonate compound, an unsaturated cyclic carbonate compound, or a combination thereof; and
01-5 wt % of a third additive, wherein the third additive comprises an organic phosphite compound, an amine, a sultone, an imide, or a combination thereof,
wherein the second additive is not the same as the one or more carbonate compounds of the nonaqueous carbonate-based solvent, and
wherein if the lithium salt comprises LiFSI, then the third additive does not comprise LiFSI.

2. The electrolyte of claim 1, comprising:
2-2 M lithium salt;
01-0.2 M of the first additive;
1-2 wt % of the second additive; and
0.1-2 wt % of the third additive.

3. The electrolyte of claim 1, wherein:
the lithium salt comprises lithium hexafluorophosphate (LiPF₆ ); and
the first additive is cesium hexafluorophosphate (CsPF₆).

4. The electrolyte of claim 1, wherein the nonaqueous carbonate-based solvent comprises ethylene carbonate (EC), propylene carbonate (PC), ethyl methyl carbonate (EMC), diethyl carbonate (DEC), dimethyl carbonate (DMC), dipropyl carbonate (DPC), di(2,2,2-trifluoroethyl) carbonate (DTFEC), methyl 2,2,2-trifluoroethyl carbonate (MTFEC), or a combination thereof.

5. The electrolyte of claim 4, wherein the nonaqueous carbonate-based solvent consists essentially of EC, PC, and EMC.

6. The electrolyte of claim 4, wherein the nonaqueous carbonate-based solvent consists essentially of EC, PC, EMC, DEC, and DMC.

7. The electrolyte of claim 1, wherein the second additive comprises fluoroethylene carbonate (FEC), difluoroethylene carbonate (DFEC), vinylene carbonate (VC), vinyl ethylene carbonate (VEC), 4-methylene ethylene carbonate (MEC), 4,5-dimethylene ethylene carbonate (DMEC), or a combination thereof.

8. The electrolyte of claim 1, wherein the third additive comprises tris(trimethylsilyl)phosphite (TTMSPi), N-(trimethylsilyl)diethylamine (TMSDEA), 1,3-propane sultone (PS), lithium bis(fluorosulfonyl)imide (LiFSI), or a combination thereof.

9. The electrolyte of claim 1, wherein the second additive comprises FEC or VC and the third additive comprises TTMSPi.

10. The electrolyte of claim 9, wherein the third additive further comprises PS, LiFSI, or a combination thereof.

11. The electrolyte of claim 1, comprising:
1 M lithium salt provided by 0.7-1 M LiPF₆ and 0-0.3 M lithium bis(trifluoromethanesulfonyl)imide (LiTFSI), LiBF₄, or a combination thereof;
EC, PC, and EMC;
05 M CsPF₆;
25-0.5 wt % VC, 0.25-0.5 wt % FEC, or 0.25-0.5 wt % FEC+VC; and
0.5 wt % TTMSPi.

12. The electrolyte of claim 11, further comprising 0.25-1 wt % PS, 0.25-1 wt % LiFSI, or a combination thereof.

13. The electrolyte of claim 1, consisting essentially of:
LiPF_{6,} or LiPF₆ in combination with LiTFSI, LiBF₄, or LiTFSI and LiBF₄;
EC, PC, and EMC;
CsPF₆;
FEC, VC, or FEC and VC;
TTMSPi;
0-5 wt % PS; and
0-5 wt % LiFSI.

14. The electrolyte of claim 1, consisting essentially of:
(i) 1 M lithium salt provided by LiPF₆ or (ii) 0.7-0.8 M LiPF₆ and 0.2-0.3 M LiTFSI, LiBF₄, or LiTFSI and LiBF₄;
EC:PC:EMC in a weight ratio of 1:1:8;
0.05 M CsPF₆;
25-0.5 wt % FEC or 0.25-0.5 wt % VC;
5 wt % TTMSPi;
0-0.5 wt % PS; and
0-1.5 wt % LiFSI.

15. The electrolyte of claim 1, consisting essentially of:
(i) 0.8 M LiPF₆ and 0.2 M LiTFSI, or (ii) 0.7 M LiPF₆ and 0.3 M LiBF₄;
EC:PC:EMC in a weight ratio of 1:1:8;
0.05 M CsPF₆;
0.25 wt % VC;
0.5 wt % TTMSPi;
0.5 wt % PS; and
0.25 wt % LiFSI.

16. The electrolyte of claim 1, consisting essentially of:
1 M LiPF₆;
EC:PC:EMC in a weight ratio of 1:1:8 or EC:PC:EMC:DEC:DMC in a weight ratio of 1:1:4:2:2;
0.05 M CsPF₆;
0.25 wt % FEC;
0.5 wt % TTMSPi;
0.5 wt % PS; and
0.25 wt % LiFSI.

17. A lithium ion battery system, comprising:
an anode;
a cathode; and
an electrolyte according to claim 1,
wherein the battery is operable over a temperature range of from −50° C. to 60° C.

18. The battery system of claim 17, wherein:
the anode is a carbon-based anode; and
the cathode comprises a lithium transition metal oxide or a lithium transition metal phosphate.

19. The battery system of claim 17, wherein:
the anode comprises graphite;
the cathode comprises a lithium transition metal oxide; and
the electrolyte comprises
5-1.5 M lithium salt,
0.025-0.1 M of the first additive,
0.25-1 wt % of the second additive, and
0.25-2 wt % of the third additive.

20. The battery system of claim 17, wherein the electrolyte consists essentially of:
1 M lithium salt provided by LiPF₆ or LiPF₆ in combination with LiTFSI, LiBF₄, or LiTFSI and LiBF₄;
EC, PC, and EMC in a weight ratio of 1:1:8 or EC:PC:EMC:DEC:DMC in a weight ratio of 1:1:4:2:2;
0.5 M CsPF₆;
0.25-0.5 wt % VC, 0.25-0.5 wt % FEC, or 0.25-0.5 wt % FEC+VC;
0.5 wt % TTMSPi;
0-0.5 wt % PS; and
0-1 wt % LiFSI.
